(19) United States
(12) Patent Application Publication
(10) Pub. No.: US 2013/0316134 A1
(43) Pub. Date: Nov. 28, 2013

(54) Structural Insulated Panel with Integrated Foam Spacer and Method of Manufacture

(71) Applicants: Scott C. Anderson, Lafayette, CO (US); Dennis W. Clark, Erie, CO (US); Wayne R. Willkomm, Erie, CO (US)

(72) Inventors: Scott C. Anderson, Lafayette, CO (US); Dennis W. Clark, Erie, CO (US); Wayne R. Willkomm, Erie, CO (US)

(73) Assignee: Earthcore Worldwide, Inc., Lafayette, CO (US)

(21) Appl. No.: 13/481,556

(22) Filed: May 25, 2012

(51) Int. Cl. B32B 3/22; B32B 5/18; B32B 37/14; B32B 3/10

(52) U.S. Cl. 428/138; 428/201; 428/194; 29/897.32

(57) ABSTRACT

An insulated wall panel comprising of two outer layers, an insulating foam core, and a spacer within the foam core which holds the panel spacing and retains the foam during foam introduction and expansion in the cavity and remains as part of the panel. The panel has no thermal bridging between the outer layers and is manufactured with reduced need of rigid mold forms. The final effect after pouring becomes a monolithic foam core of substantially consistent material and provides a superior product to using dissimilar retained spacing materials.

### FIELD OF THE INVENTION

The present invention relates to the construction and manufacture of building panels for residential, light construction, and commercial building construction.

### BACKGROUND OF THE INVENTION

Structural insulated panels produced with polyurethane cores are finding increasing marketplace demand because of their excellent insulation value achievable in a small space without sacrificing structural integrity. Polyurethane structural insulated panels are typically produced with a mold form to hold the outer layers a prescribed distance apart and to keep the expanding foam within the cavity. However, this method requires the significant costs for mold forms and limits production flexibility. Traditional spacers must be removed during the pouring process in a timed manner that adds cost and complexity to the foam pouring process. When traditionally used spacer materials remain in the panel they do not create a reduction in pour mold requirements or reduction in pouring costs, and result in dissimilar core values with engineering and thermal bridging dissimilar to the foam core monolith.

### DETAILED DESCRIPTION OF THE INVENTION

A feature of the present invention is in the structure of the structural insulated panel where insulating foam is fixed in place around the edges of the panel between the two outer layers to form the border and spacers for a cavity which is filled with expanding foam. The foam spacer holds the outer layers apart by a prescribed distance and serves to hold the expanding foam within the cavity.

The foam can be fixed in place by any number of methods which would include gluing, stapling, nailing, or screwing, for example. Additionally the foam spacer could be formed in place by pouring or spraying an expanding foam between the outer layers.

The foam spacer can also be configured as a tongue and groove pattern, so that panels placed into a wall and interlock for good air sealing and structural properties.

The foam spacer can also be made by cutting strips from a structural insulated panel that has the same total width as the target core of the panel being produced.

The foam spacer will generally have a hole cut into it on one side to allow the introduction of the foaming insulation. The invention would also include smaller holes cut in an edge of a panel to vent the air out of the cavity.

The use of foam spacers create flexibility in how panels are configured, manufactured, and used. For example, foam spacers can be used to introduce conduit into the panel structure. Panels can be manufactured specially to create a panel full of conduit molded inside the foam. These panels can then be cut to produce several spacers with conduit, which in turn can be used to assemble hollow core panels for filling with insulating foam. The foam spacers with conduit can actually be placed anywhere inside the panel as needed for the placement of electrical or other services.

The traditional manufacturing method with removable mold forms has been designed to mold a single panel in each press cycle. In fact most process and material handling developments have focused on efficiently handling a single panel. Building a complete hollow core form that can be filled with expanding foam is an enabling technology to allow multiple panels to be produced in a single press cycle.

The preferred embodiment of this invention is where the foam of the spacer and the foam of the insulating foam core are the same. However, the foam spacers provide an opportunity to fill the hollow core of the panel with a dissimilar material to achieve different mechanical properties as needed for specific applications. The panels could be filled with concrete, gypsum, or various filled thermoplastic or thermosetting foams or composites.

Exemplary embodiments, aspects and variations are illustrated in the figures and drawings, and it is intended that the embodiments, aspects and variations, and the figures and drawings disclosed herein are to be considered illustrative and not limiting.

In one embodiment, the present invention is a structural insulated panel wherein two parallel outer layers and an insulating foam core where the parts of the foam core are an insulating foam fixed in place prior to the foam filling process that create the correct spacing for the foam filling process and which remain as part of the insulating panel core.
In one embodiment, the present invention is a structural insulated panel wherein the outer layers are selected from the group consisting of paper, reinforced paper composites, oriented strand board, fiber-board, drywall, gypsum, gypsum composites, magnesium oxide, magnesium oxide composites, wood, wood composites, plywood, thermoplastics, plastic composites, carbon fiber, resins, metals, metal alloys, metal composites, and combinations thereof.

In one variation of the embodiment, the present invention is a structural insulated panel wherein one or more of the foam pieces create a cavity for foam pouring and remain as a border after pouring. In one embodiment, the present invention is a structural insulated panel wherein one or more additional foam pieces are fixed internally to create a plurality of cavities to fill with foam. In one embodiment, the present invention is a structural insulated panel wherein the foam spacer is rigid polyurethane or polyisocyanurate foam.

In another embodiment, the present invention is a structural insulated panel wherein the foam spacer is glued in place. In one embodiment, the present invention is a structural insulated panel wherein the foam spacer is nailed in place. In one embodiment, the present invention is a structural insulated panel wherein the foam spacer is screwed in place. In one embodiment, the present invention is a structural insulated panel wherein the foam spacer is stapled in place. In one embodiment, the present invention is a structural insulated panel wherein the foam spacer is poured and foamed in place. In one embodiment, the present invention is a structural insulated panel wherein where the foam spacer is sprayed and foamed in place.

In another embodiment, the present invention is a structural insulated panel wherein the foam spacer is flush with the edge of the outer layers. In one embodiment, the present invention is a structural insulated panel wherein the foam spacer is inset from the edge of the outer layers. In one embodiment, the present invention is a structural insulated panel wherein the foam spacer is protruding from the edge of the outer layers. In one embodiment, the present invention is a structural insulated panel wherein the foam spacer is a narrow strip of a structural insulated panel comprising of two parallel outer layers and an insulating foam core. In one embodiment, the present invention is a structural insulated panel wherein the flatness of the panel is enhanced by the addition one or more foam spacer blocks are placing internal to the cavity.

In one embodiment, the present invention is a structural insulated panel wherein the foam spacer includes a conduit for electrical services. In one embodiment, the present invention is a structural insulated panel wherein one or more additional foam spacers which includes a conduit for electrical services, placed anywhere in the panel. In one embodiment, the present invention is a hollow core panel wherein two parallel outer layers and an insulating foam spacer where the foam spacer surrounding a hollow cavity and holds the two outer layers parallel to each other.

In one embodiment, the present invention is a hollow core panel wherein the outer layers are selected from the group consisting of paper, reinforced paper composites, oriented strand board, fiber-board, drywall, gypsum, gypsum composites, magnesium oxide, magnesium oxide composites, wood, wood composites, plywood, thermoplastics, plastic composites, resins, carbon fiber, metals, metal alloys, metal composites, and combinations thereof.

In one variation of the embodiment, the panel above bears one or more additional foam pieces fixed internally to create a plurality of cavities to fill with foam. In one embodiment the invention above is a panel where a hole is cut into the foam boarder for the foam filling of the core. In one embodiment the invention above is a panel where vent holes are cut into the foam boarder.

In one embodiment the invention above is a panel where the foam spacer is rigid polyurethane or polyisocyanurate foam. In one variation of the embodiment, the invention above is a panel where the foam spacer is glued in place. In one embodiment the invention above is a panel where the foam spacer is nailed in place. In one embodiment the invention above is a panel where the foam spacer is screwed in place. In one embodiment the invention above is a panel where the foam spacer is stapled in place. In one embodiment the invention above is a panel where the foam spacer is poured and foamed in place. In one variation of the embodiment, the invention above is a panel where the foam spacer is sprayed and foamed in place. In one embodiment the invention above is a panel where the foam spacer is flush with the edge of the outer layers. In one embodiment the invention above is a panel where the foam spacer is inset from the edge of the outer layers.

In one variation of the embodiment, the invention above is a panel where the foam spacer is a narrow strip of a structural insulated panel comprising of two parallel outer layers and an insulating foam core. In one embodiment the invention is a panel where one or more foam spacer blocks are placed internal to the cavity. In one embodiment the invention above is a panel where the foam spacer includes a conduit for electrical services. In one variation of the embodiment, the invention above is a panel where one or more additional foam spacers which includes a conduit placed anywhere in the panel. In one embodiment the invention above is a panel where the conduit is used to introduce utility services or mechanical elements. In one embodiment the invention above is a panel where one or more additional foam spacers are configured to form a conduit within the panel. In one embodiment of the invention above, the conduit is used to introduce utility services or mechanical elements.

In one variation of the embodiment above, the invention above is a panel where the mechanical element is concrete, gypsum, filled thermoplastic or thermosetting foams or composites, steel, or other metals.

In one embodiment, the invention is a structural insulated panel comprising of two parallel outer layers and an insulating foam core where the spacer of the foam core is an insulating foam placed into the mold to hold the outer layers separate and parallel, and the spacer is attached to the panel by adhesion to the foam core. In one embodiment, the invention above is a structural insulated panel wherein the foam spacer is rigid polyurethane or polyisocyanurate foam. In one embodiment the invention is a structural insulated panel comprising wherein the foam spacer is a narrow strip of a structural insulated panel comprising of two parallel outer layers and an insulating foam core.

In one embodiment the invention is a method of making a structural insulated panel comprising of two parallel outer layers and an insulating foam core where the spacer of the foam core is an insulating foam fixed in place prior to the foam filling process and remains as part of the insulating core, where the said method comprising the step of: a) attaching the foam spacer to one outer layer; b) attaching the second outer layer to the foam spacer; c) placing the assembled hollow core panel into a press; d) introducing the foaming insulation into the core by means of a hole cut into the spacer; e) allowing the foam to cure; f) remove from the press.

In one embodiment the invention is a method of making structural insulated panels comprising of two parallel outer layers and an insulating foam core where the spacer of the foam core is an insulating foam fixed in place prior to the foam filling process and remains as part of the insulating core, where a plurality of panels is held in the press during foam expansion and curing.

In one variation of the above embodiment, the invention is a method of making structural insulated panels where the panels are separated by caul plates.

In one embodiment, the invention is a method of making structural insulated panels where the panels are filled simultaneously.

In one embodiment, the invention is a method of making structural insulated panels where the panels are filled sequentially.

### BRIEF DESCRIPTION OF THE DRAWINGS

FIG. 1 Assembled hollow core panel showing two outer layers and inset foam spacer, prior to foam filling.

FIG. 2. Foam spacer attached to one outer layer, showing the cavity to be filled.

FIG. 3 Top view of inset foam spacer attached to one outer layer, showing the cavity to be filled.

FIG. 4 Side view of inset foam spacer attached to one outer layer, showing the cavity to be filled.

FIG. 5 Top view of flush foam spacer attached to one outer layer, showing the cavity to be filled.

FIG. 6 Side view of flush foam spacer attached to one outer layer, showing the cavity to be filled.

FIG. 7 Top view of inset foam spacer attached to one outer layer, showing a plurality of cavities to be filled.

FIG. 8 Top view of flush foam spacer along edge attached plus an internal block foam spacer attached to one outer layer, showing the cavity to be filled.

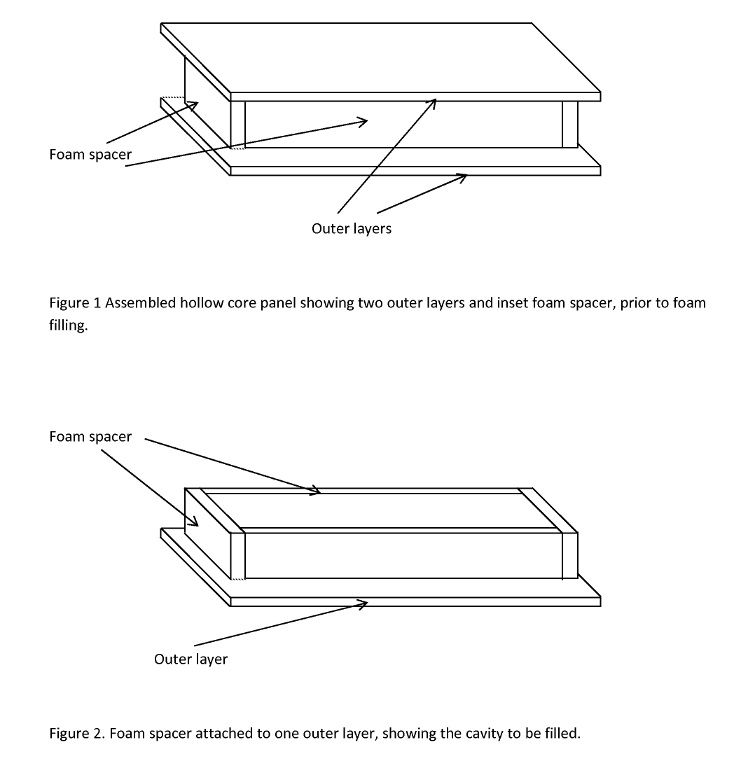

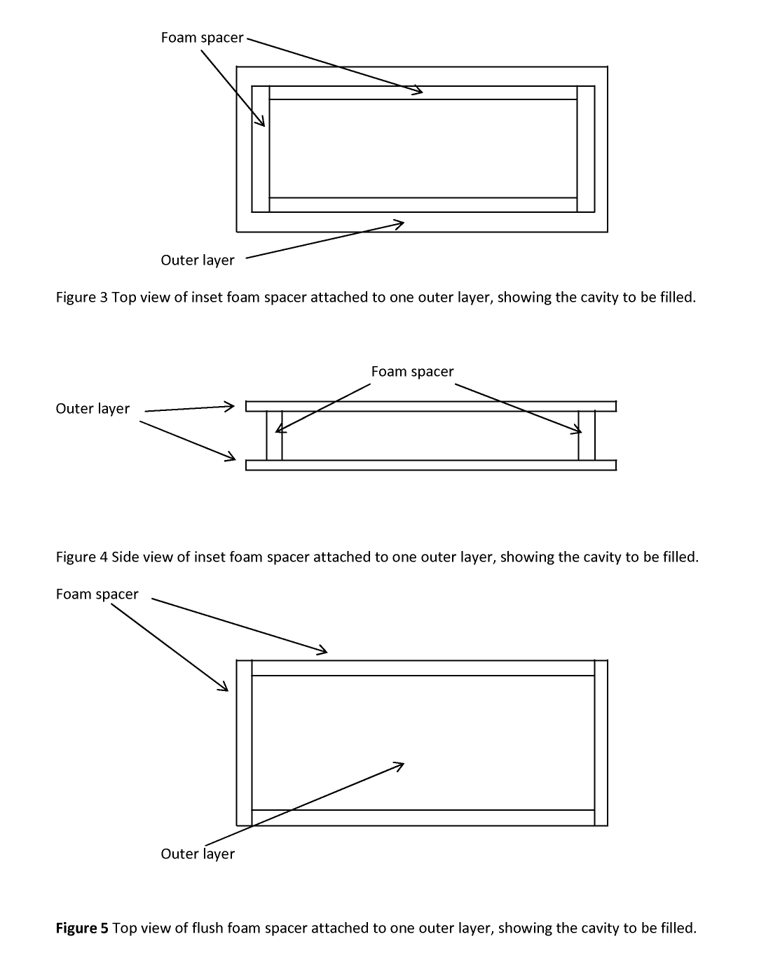

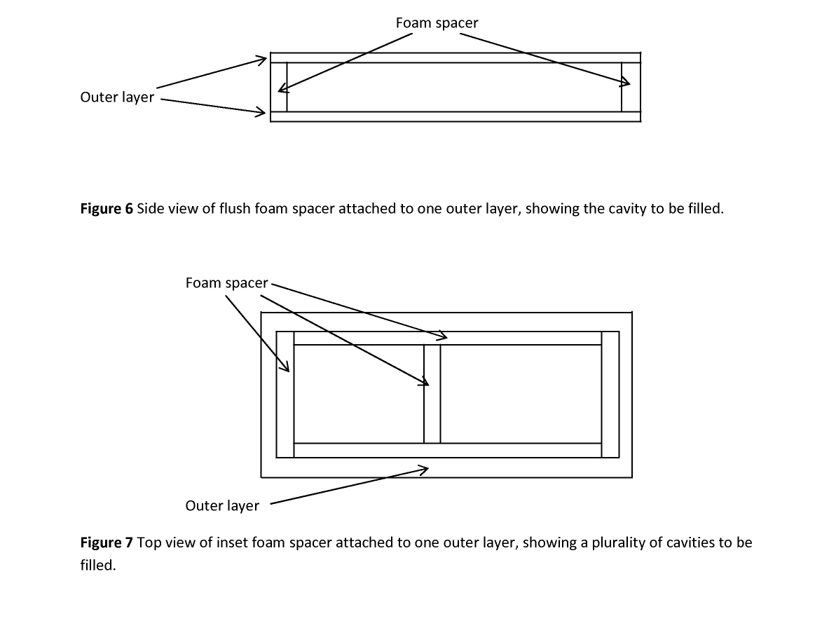

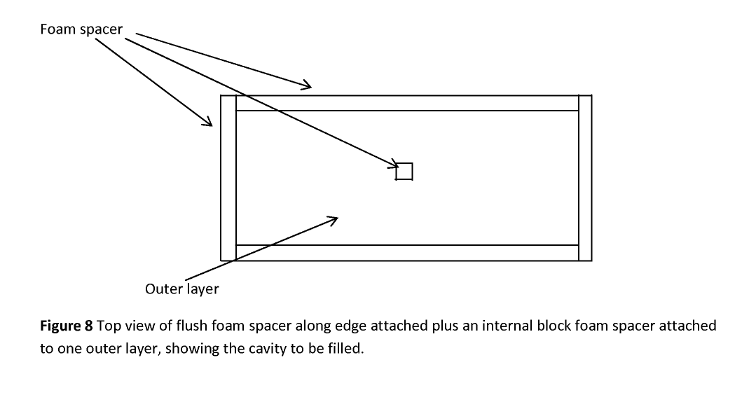

What is claimed is:

1. A structural insulated panel comprising of two parallel outer layers and an insulating foam core where the parts of the foam core are an insulating foam fixed in place prior to the foam filling process that create the correct spacing for the foam filling process and which remain as part of the insulating panel core.

2. The structural insulated panel of claim 1 wherein the outer layers are selected from the group consisting of paper, reinforced paper composites, oriented strand board, fiber-board, drywall, gypsum, gypsum composites, magnesium oxide, magnesium oxide composites, wood, wood composites, plywood, thermoplastics, plastic composites, carbon fiber, resins, metals, metal alloys, metal composites, and combinations thereof.

3. The panel of claim 2 where one or more of the foam pieces create a cavity for foam pouring and remain as a border after pouring.

4. The panel of claim 2 where one or more additional foam pieces are fixed internally to create a plurality of cavities to fill with foam.

5. The panel of claim 2 where the foam spacer is rigid polyurethane or polyisocyanurate foam.

6. The panel of claim 2 where the foam spacer is glued in place.

7. The panel of claim 2 where the foam spacer is nailed in place.

8. The panel of claim 2 where the foam spacer is screwed in place.

9. The panel of claim 2 where the foam spacer is stapled in place.

10. The panel of claim 2 where the foam spacer is poured and foamed in place.

11. The panel of claim 2 where the foam spacer is sprayed and foamed in place.

12. The panel of claim 2 where the foam spacer is flush with the edge of the outer layers.

13. The panel of claim 2 where the foam spacer is inset from the edge of the outer layers.

14. The panel of claim 2 where the foam spacer is protruding from the edge of the outer layers.

15. The panel of claim 2 where the foam spacer is a narrow strip of a structural insulated panel comprising of two parallel outer layers and an insulating foam core.

16. The panel of claim 2 where the flatness of the panel is enhanced by the addition one or more foam spacer blocks are placing internal to the cavity.

17. The panel of claim 2 where the foam spacer includes a conduit for electrical services.

18. The panel of claim 2 with one or more additional foam spacers which includes a conduit for electrical services, placed anywhere in the panel.

19. A hollow core panel comprising of two parallel outer layers and an insulating foam spacer where the foam spacer surrounding a hollow cavity and holds the two outer layers parallel to each other.

20. The hollow core panel of claim 19 wherein the outer layers are selected from the group consisting of paper, reinforced paper composites, oriented strand board, fiber-board, drywall, gypsum, gypsum composites, magnesium oxide, magnesium oxide composites, wood, wood composites, plywood, thermoplastics, plastic composites, resins, carbon fiber, metals, metal alloys, metal composites, and combinations thereof.

21. The panel of claim 20 where one or more additional foam pieces are fixed internally to create a plurality of cavities to fill with foam.

22. The panel of claim 20 where a hole is cut into the foam boarder for the foam filling of the core

23. The panel of claim 20 where vent holes are cut into the foam boarder.

24. The panel of claim 20 where the foam spacer is rigid polyurethane or polyisocyanurate foam.

25. The panel of claim 20 where the foam spacer is glued in place.

26. The panel of claim 20 where the foam spacer is nailed in place.

27. The panel of claim 20 where the foam spacer is screwed in place.

28. The panel of claim 20 where the foam spacer is stapled in place.

29. The panel of claim 20 where the foam spacer is poured and foamed in place.

30. The panel of claim 20 where the foam spacer is sprayed and foamed in place.

31. The panel of claim 20 where the foam spacer is flush with the edge of the outer layers.

32. The panel of claim 20 where the foam spacer is inset from the edge of the outer layers.

33. The panel of claim 20 where the foam spacer is a narrow strip of a structural insulated panel comprising of two parallel outer layers and an insulating foam core.

34. The panel of claim 20 where one or more foam spacer blocks are placed internal to the cavity.

35. The panel of claim 20 where the foam spacer includes a conduit for electrical services.

36. The panel of claim 20 with one or more additional foam spacers which includes a conduit placed anywhere in the panel.

37. The panel of claim 36 where the conduit is used to introduce utility services or mechanical elements.

38. The panel of claim 20 where one or more additional foam spacers are configured to form a conduit within the panel.

39. The panel of claim 38 where the conduit is used to introduce utility services or mechanical elements.

40. The panel of claim 39 with the mechanical element is concrete, gypsum, filled thermoplastic or thermosetting foams or composites, steel, or other metals.

41. A structural insulated panel comprising of two parallel outer layers and an insulating foam core where the spacer of the foam core is an insulating foam placed into the mold to hold the outer layers separate and parallel, and the spacer is attached to the panel by adhesion to the foam core.

42. The panel of claim 41 where the foam spacer is rigid polyurethane or polyisocyanurate foam.

43. The panel of claim 41 where the foam spacer is a narrow strip of a structural insulated panel comprising of two parallel outer layers and an insulating foam core.

44. A method of making a structural insulated panel comprising of two parallel outer layers and an insulating foam core where the spacer of the foam core is an insulating foam fixed in place prior to the foam filling process and remains as part of the insulating core, where the said method comprising the step of: a) attaching the foam spacer to one outer layer; b) attaching the second outer layer to the foam spacer; c) placing the assembled hollow core panel into a press; d) introducing the foaming insulation into the core by means of a hole cut into the spacer; e) allowing the foam to cure; f) remove from the press.

45. A method of making structural insulated panels comprising of two parallel outer layers and an insulating foam core where the spacer of the foam core is an insulating foam fixed in place prior to the foam filling process and remains as part of the insulating core, where a plurality of panels is held in the press during foam expansion and curing.

46. The method of claim 45 where the panels are separated by caul plates.

47. The method of claim 45 where the panels are filled simultaneously.

48. The method of claim 45 where the panels are filled sequentially.
